(19) United States
(12) Patent Application Publication
(10) Pub. No.: US 2022/0081933 A1
(43) Pub. Date: Mar. 17, 2022

(54) LOCK AND CASE HAVING THE SAME

(71) Applicant: SINOX LOCK (KUNSHAN) CO., LTD., Kunshan (CN)

(72) Inventor: Xiaodi ZHANG, Kunshan (CN)

(21) Appl. No.: 17/464,982

(22) Filed: Sep. 2, 2021

(30) Foreign Application Priority Data
Sep. 15, 2020 (CN) 202010968382.2

(51) Int. Cl. E05B 37/00; E05B 65/52; E05B 37/02

(52) U.S. Cl. CPC E05B 37/0037; E05B 37/02; E05B 65/5238

(57) ABSTRACT

Provided are a lock and a case having the same. The lock includes a lock tongue; a key lock mechanism including a lock core and a lock block; and a password wheel lock mechanism including a spindle and a password wheel. When the password wheel and the lock core are locked, the spindle and the lock block are locked by the password wheel and the lock core, respectively. The spindle abuts against the lock block and the lock block abuts against the lock tongue so that the lock tongue is kept in a locking position. When the password wheel is unlocked, the spindle cancels the abutting against the lock block and the lock block cancels the abutting against the lock tongue. When the lock core is unlocked, the lock block is driven to move to an avoidance position so that the lock block cancels the abutting against the lock tongue.

### CROSS-REFERENCE TO RELATED APPLICATION(S)

This application claims priority to Chinese Patent Application No. 202010968382.2 filed Sep. 15, 2020, the disclosure of which is incorporated herein by reference in its entirety.

### TECHNICAL FIELD

The present disclosure relates to the technical field of locks and in particular to a lock and a case having the same.

### BACKGROUND

In order to ensure the safety of luggage, people often use case having locks on it to carry items when they going outsides. The case includes, but is not limited to, a luggage case, a suitcase, and a briefcase.

Generally, the lock of the luggage case is used in combination with the zipper of the case body. When the zipper is zipped up, a zipper puller may be inserted or clamped in the locking hole of the above-mentioned lock. Then a component such as a lock tongue which is movable and actuated in the locking hole of the above-mentioned lock penetrates through a hole in the head of the zipper puller to achieve the purpose of locking the zipper.

Such lock typically includes a password wheel lock which is suitable for being unlocked through the operation of a password wheel by a user and a transportation security administration (TSA) key lock (commonly known as a customs lock) which is suitable for being unlocked through the operation of a key by a user, particularly a customs verifier, which makes the existing lock complex in structure, large in size, and occupy space of the case.

### SUMMARY

The objective of the present disclosure is to provide a lock and a case having the same. The lock is simple in structure and small in size.

To achieve this objective, the present disclosure adopts solutions described below.

A lock includes a housing and further includes a lock tongue, a key lock mechanism, a password wheel lock mechanism which are sequentially disposed in the housing. The password wheel lock mechanism includes a spindle and a password wheel and the key lock mechanism includes a lock core and a lock block.

When both the password wheel and the lock core are locked, the spindle and the lock block are configured to be locked by the password wheel and the lock core respectively; the spindle is configured to abut against the lock block; the lock block is configured to abut against the lock tongue so that the lock tongue is kept in a locking position; and when the password wheel is unlocked, the spindle is configured to cancel the abutting against the lock block and furthermore the lock block is configured to cancel the abutting against the lock tongue.

When the lock core is unlocked, the lock block is capable of being driven to move to an avoidance position so that the lock block cancels the abutting against the lock tongue.

In an embodiment, the lock further includes a push button; the push button is slidably mounted on the housing and the push button is configured to hook the lock tongue; and when the lock block cancels the abutting against the lock tongue, the push button is capable of driving the lock tongue to move to an unlocking position.

In an embodiment, the push button has a mounting hole and the lock core is rotatably disposed in the mounting hole.

In an embodiment, the push button has a limiting portion, and the limiting portion is configured to limit a rotation stroke of the lock core.

In an embodiment, the lock block has a first end and a second end which are opposite to each other; the first end is hinged with the spindle; and the second end is configured to abut against the lock tongue.

The lock block is provided with a first slot at the second end or adjacent to the second end, an eccentric protrusion disposed at a bottom of the lock core is inserted into the first slot, and the eccentric protrusion slidable along the first slot so that when the lock core rotates, the eccentric protrusion is capable of driving the lock block to deflect to the avoidance position.

In an embodiment, the first slot includes a first guide section and a second guide section connected to the first guide section; when the lock core is locked, the first guide section is parallel to an unlocking movement direction of the lock tongue; and when the lock core is unlocked, the second guide section is parallel to the unlocking movement direction of the lock tongue.

In an embodiment, the lock block is slidably connected to the housing; the lock block has a second slot; an eccentric protrusion disposed at a bottom of the lock core is inserted into the second slot; and the eccentric protrusion is slidable along the second slot so that when the lock core rotates, the eccentric protrusion is capable of driving the lock block to slide to the avoidance position.

In an embodiment, the lock block includes a lock core stop block and a connection rod; the lock core stop block is slidably connected to the housing; the second slot is formed and the connection rod is slidably connected to the second slot; when the lock core is locked, two ends of the connection rod abut against the spindle and the lock tongue, respectively; and the connection rod is limited by the lock core stop block so that the connection rod is slidable only along a direction which is parallel to an unlocking movement direction of the lock tongue.

In an embodiment, an elastic element is disposed between the connection rod and the lock core stop block, and the elastic element is configured to enable the connection rod to keep abutting against the lock tongue.

To achieve this objective, the present disclosure further adopts the solution described below.

A case includes the above-mentioned lock.

The present disclosure has the beneficial effects described below.

The lock provided by the present disclosure has a simple structure. The locking and unlocking actions of the key lock mechanism and the password wheel lock mechanism may be independently performed, and the key lock mechanism and the password wheel lock mechanism may cooperate with each other to lock zipper pullers to ensure the locking effect of the case. Meanwhile, the lock block which is movable for avoidance is more suitable for a housing of a small size and the housing of a smaller size is allowed to be produced. Thus, the lock has a simple structure and also meets the practical use requirement for occupying small space.

### BRIEF DESCRIPTION OF DRAWINGS

FIG. 1 is a structure view of a lock according to embodiment one of the present disclosure;

FIG. 2 is a structure view of a lock with a bottom plate being not disposed according to embodiment one of the present disclosure;

FIG. 3 is a structure view of a key lock mechanism when being locked according to embodiment one of the present disclosure;

FIG. 4 is a structure view of a key lock mechanism when being unlocked according to embodiment one of the present disclosure;

FIG. 5 is a schematic view showing a structure when a lock core cooperates with a push button according to embodiment one of the present disclosure;

FIG. 6 is an exploded view of a spindle, a lock core, and a lock block according to embodiment one of the present disclosure;

FIG. 7 is a structure view of a lock with a top cover being not disposed according to embodiment two of the present disclosure;

FIG. 8 is a structure view of a lock with a bottom plate being not disposed according to embodiment two of the present disclosure;

FIG. 9 is a structure view of a key lock mechanism when being locked according to embodiment two of the present disclosure; and

FIG. 10 is an exploded view of a push button, a lock core, and a lock block according to embodiment two of the present disclosure.

### REFERENCE LIST

1 housing

11 top cover

2 bottom plate

13 locking hole

14 sliding groove

2 lock tongue

21 first abutting part

3 key lock mechanism

31 lock core

311 limiting block

312 eccentric protrusion

32 lock block

321 first slot

3211 first guide section

3212 second guide section

322 second slot

323 lock core stop block

324 connection rod

3241 second abutting part

4 password wheel lock mechanism

41 spindle

42 password wheel

5 push button

51 mounting hole

52 limiting slot

### DETAILED DESCRIPTION

The present disclosure is further described below in detail in conjunction with drawings and embodiments. It is to be understood that the embodiments set forth below are intended to merely illustrate the present disclosure and not to limit the present disclosure. It is to be noted that to facilitate description, only part, not all, of structures related to the present disclosure are illustrated in the drawings.

In the description of the present disclosure, unless otherwise expressly specified and limited, the term “connected to each other”, “connected” or “fixed” is to be construed in a broad sense, for example, as fixedly connected, detachably connected, or integrated; mechanically connected or electrically connected; directly connected to each other or indirectly connected to each other via an intermediary; or internally connected or an interactional relationship between two components. For those of ordinary skill in the art, specific meanings of the preceding terms in the present disclosure may be understood based on specific situations.

In the present disclosure, unless otherwise expressly specified and limited, when a first feature is described as “on” or “below” a second feature, the first feature and the second feature may be in direct contact or be in contact via another feature between the two features instead of being in direct contact. Moreover, when the first feature is described as “on”, “above”, or “over” the second feature, the first feature is right on, above, or over the second feature or the first feature is obliquely on, above, or over the second feature, or the first feature is simply at a higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature.

In the description of the embodiment, the orientations or position relations indicated by terms such as “above”, “below”, “right” and the like are based on orientations or position relations shown in the drawings. These orientations or position relations are intended only to facilitate and simplify description of the present disclosure, and not to indicate or imply that a device or element referred to must have such specific orientations or must be configured or operated in such specific orientations. Therefore, these orientations or position relations are not to be construed as limiting the present disclosure. In addition, the terms “first” and “second” are used only to distinguish between descriptions and have no special meaning.

### Embodiment One

This embodiment provides a lock which is preferably used in a luggage case. However, in other optional embodiments, the lock may also be used in a suitcase, briefcase, etc. The lock has a simple structure and occupies small space.

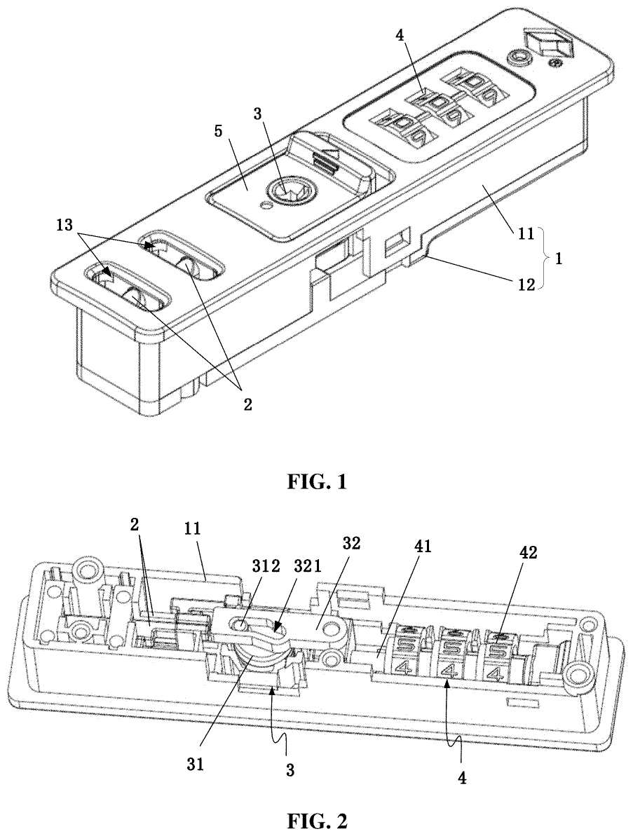

In conjunction with FIGS. 1 to 6, the lock is described below in detail by using an example in which the lock is used in a luggage case.

The luggage case includes a case body and a lock. The case body is provided with a zipper. The lock achieves the purpose of locking the zipper by locking the zipper puller of the zipper.

Referring to FIGS. 1 and 2, the lock includes a housing 1 and includes a lock tongue 2, a key lock mechanism 3, and a password wheel lock mechanism 4 which are sequentially disposed in the housing 1. As shown in FIG. 1, the housing 1 includes a top cover 11 and a bottom plate 12. The top cover 11 and the bottom plate 12 can be interlocked to form a receiving cavity. The top cover 11 is provided with a locking hole 13 for the zipper puller of the zipper mechanism to be inserted into the receiving cavity. The lock tongue 2 and the key lock mechanism 3 are each disposed in the receiving cavity. In addition, the lock tongue 2 has an unlocking position and a locking position. When the lock tongue 2 is in the unlocking position, the lock tongue 2 and the locking hole 13 are staggered to avoid each other so as to allow the zipper puller to be inserted into the retaining cavity. When the lock tongue 2 is in the locking position, the lock tongue 2 extends into the perforation in the head of the zipper puller to lock the zipper puller, thus ensuring that the case body is kept in a closed state.

The key lock mechanism 3 includes a lock core 31 into which a key may be inserted from the outside of the housing 1 and includes a lock block 32 which is linked with the lock core 31. The lock core 31 is unlocked through a correct key so that the lock core 31 rotates and drives the lock block 32 to perform locking and unlocking actions. The password wheel lock mechanism 4 includes a spindle 41 and a plurality of password wheels 42 which are disposed on the spindle 41. The spindle 41 is unlocked when the password wheels 42 are in the correct position so that the spindle 41 can move along the axial direction of the spindle 41. On the contrary, the spindle 41 is locked when the password wheels 42 are in the wrong position so that the axial movement of the spindle 41 is limited.

The lock tongue 2, the key lock mechanism 3, and the password wheel lock mechanism 4 are sequentially disposed. When the password wheel 42 and the lock core 31 are each locked, the spindle 41 and the lock block 32 are locked by the password wheel 42 and the lock core 31, respectively. In this case, the spindle 41 abuts against the lock block 32 and the lock block 32 abuts against the lock tongue 2 so that the lock tongue 2 is kept in the locking position to ensure that the zipper is zipped up.

When a user needs to unlock and open the luggage case through the password wheel 42 and the password wheel 42 is moved to the correct position for unlocking, the spindle 41 is in an active state, that is, the abutting against the lock block 32 is canceled. Then the abutting of the lock block 32 against the lock tongue 2 is canceled so that the lock tongue 2 can move to the unlocking position and the zipper puller is unlocked. Furthermore, the zipper is opened through the zipper puller so that the luggage case can be opened.

When the user unlocks and opens the luggage case through a key, the key is inserted into the lock core 31 and the lock core 31 is rotated for unlocking so that the lock core 31 drives the lock block 32 to move to an avoidance position. Thus, the lock block 32 can cancel the abutting against the lock tongue 2 and the lock tongue 2 can move to the unlocking position to make the zipper puller unlocked. Furthermore, the zipper is opened through the zipper puller so that the luggage case can be opened.

With the above-mentioned structure, the structure of the lock is simpler, and the key lock mechanism 3 and the password wheel lock mechanism 4 may not only be subjected to the locking and unlocking actions independently but also cooperate with each other to lock the zipper puller to ensure the locking effect of the case. Meanwhile, in the key lock mechanism 3, the lock block 32 which is movable for avoidance is suitable for a housing 1 of a small size and the housing 1 of a smaller size is allowed to be produced. Thus, the lock has a simple structure and also meets the practical use requirement for occupying small space.

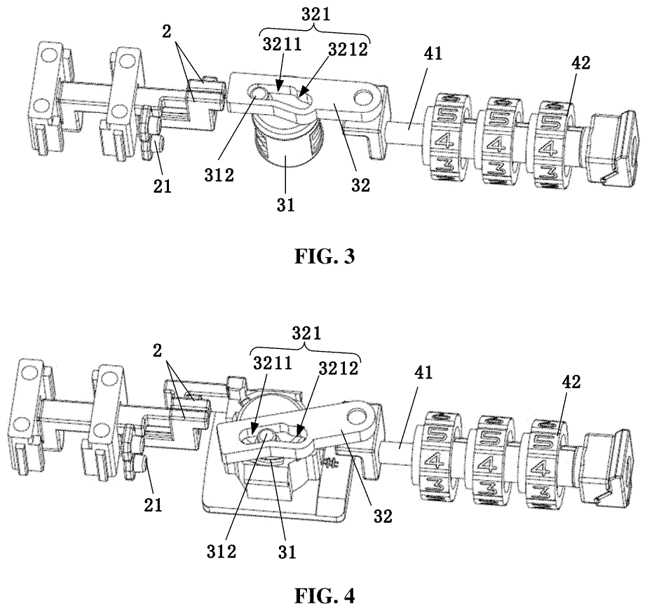

As shown in FIGS. 1 and 3, in order to facilitate the unlocking operation of a user, the lock further includes a push button 5. The push button 5 is slidably mounted at the housing 1 and hooks the lock tongue 2. When the lock block 32 cancels the abutting against the lock tongue 2, the push button 5 can drive the lock tongue 2 to move to the unlocking position.

In this embodiment, the push button 5 is provided with a mounting hole 51 and the lock core 31 is rotatably disposed in the mounting hole 51 so that when the user pushes the push button 5, the push button 5 can directly drive the lock core 31 and the lock tongue 2 to move synchronously to complete the unlocking action.

Since the unlocking action of the key lock mechanism 3 is completed in a manner that the key unlocks the lock core 31 and the lock core 31 is rotated to the unlocking position, accurate and limited rotation stroke of the lock core 31 can facilitate the rotation of the key by the user to the correct locking position and unlocking position. Therefore, in this embodiment, the push button 5 also has a limiting portion which is configured to limit the rotation stroke of the lock core 31 so that the user is prevented from confusing the locking and unlocking rotation positions and the user conveniently performs the locking and unlocking actions of the zipper through the two limit positions to which the key rotates.

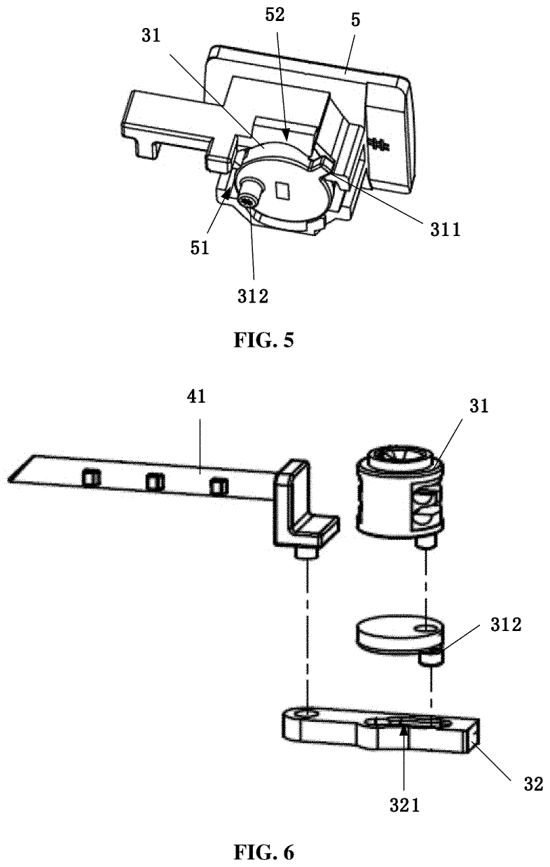

As shown in FIG. 5, the annular wall of the push button 5 which is used for the lock core 31 to be disposed is provided with a limiting slot 52 with a suitable length. Accordingly, the outer wall of the lock core 31 is provided with a limiting block 311. When the lock core 31 rotates, the limiting block 311 can just slide in the limiting slot 52. In addition, the position and length of the limiting slot 52 are configured such that when the lock core 31 rotates to the locking position and the unlocking position, the limiting block 311 is just located at the two ends of the limiting slot 52, respectively, which achieves the purpose of limiting the rotation stroke of the lock core 31.

In this embodiment, in order to enable the lock tongue 2 to be automatically reset to the locking position after being unlocked, the lock tongue 2 may be connected to or abut the housing 1 by a compression spring. When the lock tongue 2 is in the unlocking position, the compression spring is elastically deformed and elastic potential energy for resetting the lock tongue 2 to the locking position is formed.

Referring to FIGS. 3 and 4, the lock tongue 2 is provided with a first abutting part 21. A baffle is convexly disposed in the receiving cavity of the top cover 11. The compression spring is connected or abuts between the baffle and the first abutting part 21. The extension direction of the compression spring is parallel to the unlocking movement direction of the lock tongue 2. Thus, after the lock tongue 2 moves from the locking position to the unlocking position, the first abutting part 21 abuts against the compression spring to enable the compression spring to contract and store energy. When the external force for unlocking the lock tongue 2 is removed, the compression spring stretches and the lock tongue 2 reversely hooks and pulls the push button 5 to reset the lock tongue 2 to the locking position, and the whole key lock mechanism 3 is synchronously reset.

In order that the lock block 32 is enabled to move to the avoidance position by linkage when the lock core 31 rotates, in this embodiment, the lock block 32 has a first end and a second end which are opposite to each other, the first end is hinged with the spindle 41, and the second end is configured to abut against the lock tongue 2.

The lock block 32 is provided with a first slot 321 at the second end or adjacent to the second end. An eccentric protrusion 312 disposed at a bottom of the lock core 31 and eccentric to the axis of the lock core 31 is inserted into the first slot 321 and the eccentric protrusion 312 is slidable along the first slot 321. Thus, when the lock core 31 rotates, the eccentric protrusion 312 can drive the lock block 32 to deflect around the shaft by which the lock block 32 is hinged with the spindle 41 to the avoidance position so as to enable the second end to cancel the abutting against the lock tongue 2.

The first slot 321 includes a first guide section 3211 and a second guide section 3212 which are connected to each other. When the lock core 31 is locked, the first guide section 3211 is parallel to the unlocking movement direction of the lock tongue 2. When the lock core 31 is unlocked, the second guide section 3212 is parallel to the unlocking movement direction of the lock tongue 2.

It should be noted that the first slot 321 is configured to be of the above-mentioned structure for the purpose described below.

When the zipper puller is unlocked merely by the password wheel lock mechanism 4, the push button 5 and the lock core 31 which is built in the push button 5 need to move towards the password wheel lock mechanism 4 for hooking and pulling the lock tongue 2 for unlocking.

In this case, the first guide section 3211 which is parallel to the unlocking movement direction of the lock tongue 2 allows the lock core 31 to slide relative to the lock block 32. When the zipper puller is unlocked by the key lock mechanism 3, the lock core 31 is rotated by the key. The lock core 31 and the eccentric protrusion 312 which is disposed on the lock core 31 slide from the end of the first guide section 3211 farther away from the second guide section 3212 to the end of the first guide section 3211 adjacent to the second guide section 3212, and such action may drive the lock block 32 to deflect to the avoidance position. The push button 5 and the lock core 31 which is built in the push button 5 need to move towards the password wheel lock mechanism 4 to hook and pull the lock tongue 2 for unlocking. However, the lock block 32 in the avoidance position needs to keep in the position. In this case, the second guide section 3212 which is parallel to the unlocking movement direction of the lock tongue 2 allows the lock core 31 to slide relative to the lock block 32.

### Embodiment Two

In this embodiment, the structure of the lock is basically the same as the structure of the lock described in embodiment one, except that the structure of the lock block 32 and the actuation mode of the locking and unlocking actions of the lock block 32 are different.

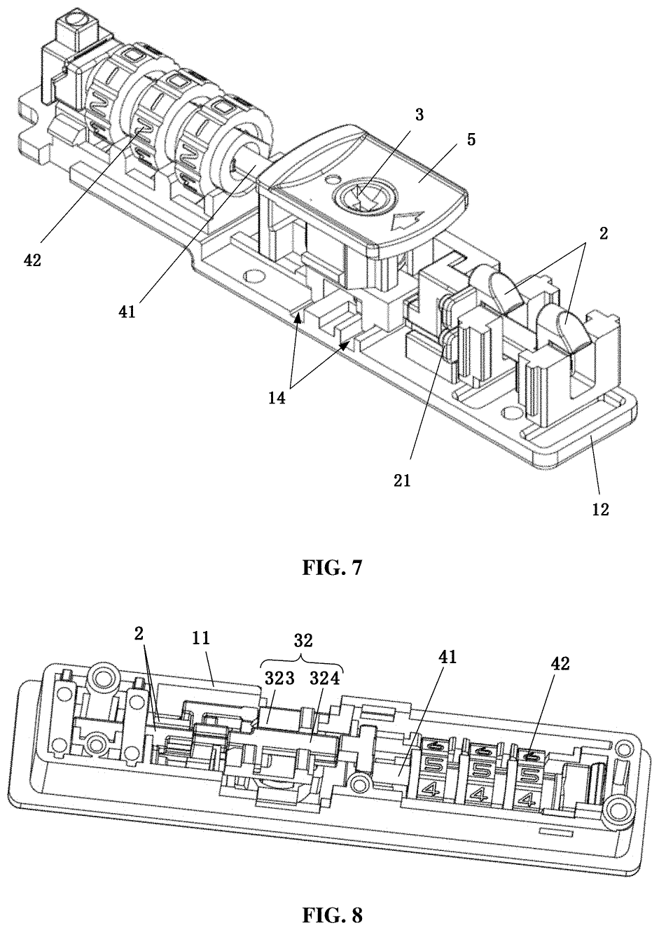

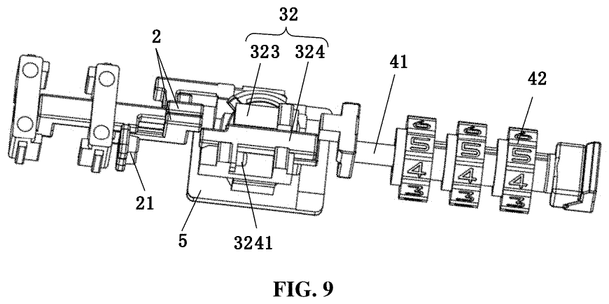

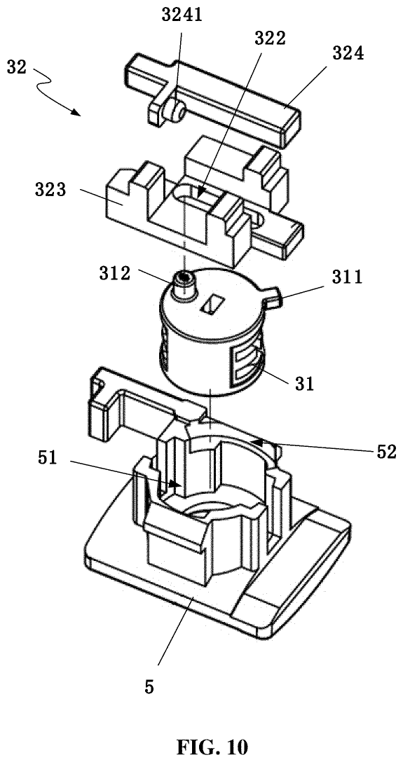

Referring to FIGS. 7 to 10, the lock block 32 is slidably connected to the housing 1 and the lock block 32 has a second slot 322. The eccentric protrusion 312 disposed at a bottom of the lock core 31 is inserted into the second slot 322 and the eccentric protrusion 312 is slidable along the second slot 322 so that when the lock core 31 rotates, the eccentric protrusion 312 can drive the lock block 32 to slide to the avoidance position.

Exemplarily, the housing 1 is provided with a sliding groove 14. The extension direction of the sliding groove 14 is perpendicular to the unlocking movement direction of the lock tongue 2 such that the lock block 32 is slidable along the direction perpendicular to the unlocking movement direction of the lock tongue 2. The extension direction of the second slot 322 is parallel to the unlocking movement direction of the lock tongue 2. When the user rotates and unlocks the lock core 31 with the key, the eccentric protrusion 312 disposed at the bottom of the lock core 31 slides along the second slot 322 and drives the lock block 32 to slide along the sliding groove 14 to the avoidance position. In this case, the user pushes the push button 5 to slide along the direction parallel to the unlocking movement direction of the lock tongue 2, and the eccentric protrusion 312 can continue to slide along the second slot 322 to hook and pull the lock tongue 2 to complete the unlocking action.

In order to facilitate the locking and unlocking actions merely performed by the password wheel lock mechanism 4, in this embodiment, the lock block 32 includes a lock core stop block 323 and a connection rod 324. The lock core stop block 323 is slidably connected to the housing 1 and the second slot 322 is formed. The connection rod 324 is slidably connected to the second slot 322. When the lock core 31 is locked, two ends of the connection rod 324 abut against the spindle 41 and the lock tongue 2, respectively. The connection rod 324 is limited by the lock core stop block 323 to be merely slidable along the direction which is parallel to the unlocking movement direction of the lock tongue 2.

In other words, in the lock block 32, the connection rod 324 is a locking execution portion which stops the lock tongue 2. The lock core stop block 323 is a linkage execution portion which is driven by the lock core 31 and drives the connection rod 324 to deflect to the avoidance position. The position of the lock core stop block 323 is limited when the locking and unlocking actions are performed merely by the password wheel lock mechanism 4 and the key lock mechanism 3 is kept locked. However, the connection rod 324 which can slide relative to the lock core stop block 323 along the direction parallel to the unlocking movement direction of the lock tongue 2 may move towards the password wheel lock mechanism 4 through being pushed against by the lock tongue 2 when the push button 5 hooks and pulls the lock tongue 2.

In addition, the split structure of the lock core stop block 323 and the connection rod 324 is also suitable for avoiding the lock tongue 2 by movement when the zipper puller is locked into the locking hole 13 so that the lock tongue 2 can complete the linear reciprocation movement of avoiding the zipper puller and resetting the locked zipper puller.

An elastic element is disposed between the connection rod 324 and the lock core stop block 323 and the elastic element is configured to enable the connection rod 324 to keep abutting against the lock tongue 2. Specifically, the connection rod 324 is provided with a second abutting part 3241 which can be connected to or abut against a compression spring serving as an elastic element. The lock core stop block 323 is provided with a wall surface which is opposite to the second abutting part 3241 so that the compression spring can be accommodated between the connection rod 324 and the lock core stop block 323. The purpose of keeping the connection rod 324 in abutment with the lock tongue 2 is achieved through the stretching elastic force of the compression spring.

Apparently, the preceding example embodiments of the present disclosure are merely used for clearly illustrating the present disclosure and are not intended to limit the implementations of the present disclosure. Those of ordinary skill in the art can make various apparent modifications, adaptations, and substitutions without departing from the scope of the present disclosure. Implementations of the present disclosure cannot be and do not need to be all exhausted herein. Any modification, equivalent, improvement and the like made within the spirit and principle of the present disclosure shall be within the scope of the claims of the present disclosure.

What is claimed is:

1. A lock, comprising a housing, a lock tongue, a key lock mechanism, and a password wheel lock mechanism; wherein
the lock tongue, the key lock mechanism, and the password wheel lock mechanism are sequentially disposed in the housing;
the password wheel lock mechanism comprises a spindle and a password wheel, and the key lock mechanism comprises a lock core and a lock block;
when both the password wheel and the lock core are locked, the spindle and the lock block are configured to be locked by the password wheel and the lock core respectively, the spindle is configured to abut against the lock block, and the lock block is configured to abut against the lock tongue so that the lock tongue is kept in a locking position;
when the password wheel is unlocked, the spindle is configured to cancel the abutting against the lock block and furthermore the lock block is configured to cancel the abutting against the lock tongue; and
when the lock core is unlocked, the lock block is capable of being driven to move to an avoidance position so that the lock block cancels the abutting against the lock tongue.

2. The lock according to claim 1, further comprising a push button, wherein the push button is slidably mounted on the housing, the push button is configured to hook the lock tongue, and when the lock block cancels the abutting against the lock tongue, the push button is capable of driving the lock tongue to move to an unlocking position.

3. The lock according to claim 2, wherein the push button has a mounting hole and the lock core is rotatably disposed in the mounting hole.

4. The lock according to claim 2, wherein the push button has a limiting portion, and the limiting portion is configured to limit a rotation stroke of the lock core.

5. The lock according to claim 1, wherein the lock block has a first end and a second end which are opposite to each other, the first end is hinged with the spindle, and the second end is configured to abut against the lock tongue; and
the lock block is provided with a first slot at the second end or adjacent to the second end, an eccentric protrusion disposed at a bottom of the lock core is inserted into the first slot, and the eccentric protrusion is slidable along the first slot so that when the lock core rotates, the eccentric protrusion is capable of driving the lock block to deflect to the avoidance position.

6. The lock according to claim 5, wherein the first slot comprises a first guide section and a second guide section connected to the first guide section; when the lock core being locked, the first guide section is parallel to an unlocking movement direction of the lock tongue; and when the lock core being unlocked, the second guide section is parallel to the unlocking movement direction of the lock tongue.

7. The lock according to claim 1, wherein the lock block is slidably connected to the housing, the lock block has a second slot, an eccentric protrusion disposed at a bottom of the lock core is inserted into the second slot, and the eccentric protrusion is slidable along the second slot so that when the lock core rotates, the eccentric protrusion is capable of driving the lock block to slide to the avoidance position.

8. The lock according to claim 7, wherein the lock block comprises a lock core stop block and a connection rod, the lock core stop block is slidably connected to the housing, the second slot is formed, the connection rod is slidably connected to the second slot;
when the lock core being locked, two ends of the connection rod are configured to abut against the spindle and the lock tongue, respectively; and
the connection rod is limited by the lock core stop block so that the connection rod is slidable only along a direction which is parallel to an unlocking movement direction of the lock tongue.

9. The lock according to claim 8, wherein an elastic element is disposed between the connection rod and the lock core stop block, and the elastic element is configured to enable the connection rod to keep abutting against the lock tongue.

10. A case, comprising a lock, wherein the lock comprises a housing, a lock tongue, a key lock mechanism, and a password wheel lock mechanism; wherein
the lock tongue, the key lock mechanism, and the password wheel lock mechanism are sequentially disposed in the housing;
the password wheel lock mechanism comprises a spindle and a password wheel, and the key lock mechanism comprises a lock core and a lock block;
when both the password wheel and the lock core are locked, the spindle and the lock block are configured to be locked by the password wheel and the lock core, respectively, the spindle is configured to abut against the lock block, and the lock block is configured to abut against the lock tongue so that the lock tongue is kept in a locking position;
when the password wheel being unlocked, the spindle is configured to cancel the abutting against the lock block and furthermore the lock block is configured to cancel the abutting against the lock tongue; and
when the lock core being unlocked, the lock block is capable of being driven to move to an avoidance position so that the lock block cancels the abutting against the lock tongue.

11. The case according to claim 10, wherein the lock further comprises a push button, wherein the push button is slidably mounted on the housing, the push button is configured to hook the lock tongue, and when the lock block cancels the abutting against the lock tongue, the push button is capable of driving the lock tongue to move to an unlocking position.

12. The case according to claim 11, wherein the push button has a mounting hole and the lock core is rotatably disposed in the mounting hole.

13. The case according to claim 11, wherein the push button has a limiting portion, and the limiting portion is configured to limit a rotation stroke of the lock core.

14. The case according to claim 10, wherein the lock block has a first end and a second end which are opposite to each other, the first end is hinged with the spindle, and the second end is configured to abut against the lock tongue; and
the lock block is provided with a first slot at the second end or adjacent to the second end, an eccentric protrusion disposed at a bottom of the lock core is inserted into the first slot, and the eccentric protrusion is slidable along the first slot so that when the lock core rotates, the eccentric protrusion is capable of driving the lock block to deflect to the avoidance position.

15. The case according to claim 14, wherein the first slot comprises a first guide section and a second guide section connected to first guide section; when the lock core being locked, the first guide section is parallel to an unlocking movement direction of the lock tongue; and when the lock core being unlocked, the second guide section is parallel to the unlocking movement direction of the lock tongue.

16. The case according to claim 10, wherein the lock block is slidably connected to the housing, the lock block has a second slot, an eccentric protrusion disposed at a bottom of the lock core is inserted into the second slot, and the eccentric protrusion is slidable along the second slot so that when the lock core rotates, the eccentric protrusion is capable of driving the lock block to slide to the avoidance position.

17. The case according to claim 16, wherein the lock block comprises a lock core stop block and a connection rod, the lock core stop block is slidably connected to the housing, the second slot is formed, the connection rod is slidably connected to the second slot;
when the lock core being locked, two ends of the connection rod are configured to abut against the spindle and the lock tongue, respectively; and
the connection rod is limited by the lock core stop block so that the connection rod is slidable only along a direction which is parallel to an unlocking movement direction of the lock tongue.

18. The case according to claim 17, wherein an elastic element is disposed between the connection rod and the lock core stop block, and the elastic element is configured to enable the connection rod to keep abutting against the lock tongue.
